(19) United States
(12) Patent Application Publication
(10) Pub. No.: US 2022/0037945 A1
(43) Pub. Date: Feb. 3, 2022

(54) ROTARY ELECTRIC MACHINE STATOR

(71) Applicant: Komatsu Ltd., Tokyo (JP)

(72) Inventors: Atsuyoshi Koshiba, Tokyo (JP); Hiroki Hijikata, Tokyo (JP); Takuya Fujikawa, Tokyo (JP); Teiichirou Chiba, Tokyo (JP)

(73) Assignee: Komatsu Ltd., Tokyo (JP)

(21) Appl. No.: 17/275,754

(22) PCT Filed: Oct. 23, 2019
(86) PCT No.: PCT/JP2019/041548

§ 371 Date: Mar. 12, 2021

(30) Foreign Application Priority Data
Oct. 31, 2018 (JP) 2018-205852

(51) Int. Cl. H02K 3/12; H02K 3/28; H02K 15/04

(52) U.S. Cl. CPC H02K 3/12; H02K 15/0421; H02K 3/28

(57) ABSTRACT

The basic coil segment is arranged in the slot such that at least part of the basic coil bent portion is arranged outside the insertion end, in an axial direction parallel to a center axis of the stator core and the pair of the basic coil insertion end portions is arranged outside the welded end, in the axial direction. The power coil segment is arranged in the slot such that the power coil lead end portion and at least part of the power coil connection portion are arranged outside the insertion end, in the axial direction and the power coil insertion end portion is arranged outside the welded end, in the axial direction. The height of an end surface of the basic coil segment from the insertion end is equal to the height of an end surface of the power coil segment from the insertion end.

### FIELD

The present invention relates to a rotary electric machine stator.

### BACKGROUND

As a kind of rotary electric machine stator, a segment conductor (SC) wound stator is known. The SC wound stator includes a stator core having slots, a basic coil wound around the stator core, and a power coil connected to the basic coil. The basic coil is wound around the stator core by an SC winding method. The SC winding method is a method in which a plurality of basic coil segments formed by segment conductors (split conductors) is inserted into slots of the stator core, and then adjacent basic coil segments are welded to wind the basic coil around the stator core. The power coil includes power coil segments, and the power coil segments are formed by segment conductors as well. The power coil segments are inserted into slots of the stator core and welded to the basic coil segment. Patent Literature 1 discloses an example of the SC wound stator having a conductor as a basic coil segment and a lead section as a power coil segment.

In manufacturing the SC wound stator, each of the basic coil segments and power coil segments is inserted into a slot from an insertion end with the insertion end of the slot facing upward. After each of the basic coil segments and power coil segments is inserted into the slot, the stator core is inverted up and down so that a welded end of the slot faces upward. The basic coil segment and the power coil segment arranged outside the welded ends of the slots are bent with the welded ends of the slots facing upward. After the bending, welding of adjacent basic coil segments and welding of a basic coil segment and a power coil segment are performed, on the welded end side of the slots.

The bending is performed while the stator core is supported by a support surface of a support member. The stator core is supported by the support member via at least the basic coil segments or the power coil segments, arranged outside the insertion ends of the slots. While the stator core is supported by the support member, a bending tool applies a circumferential force to each of the basic coil segments and power coil segments, arranged outside the welded end of the slot. Thus, the basic coil segments and the power coil segments are bent.

### CITATION LIST

### Patent Literature

Patent Literature 1: JP 2011-015459 A

### SUMMARY

### Technical Problem

If the bending tool applies a force to the basic coil segments and power coil segments that are being supported unevenly by the support member, there is a possibility that at least some of the basic coil segments and power coil segments are displaced in position, in an axial direction in parallel to a center axis of the stator core. For example, if the position of one of adjacent basic coil segments is displaced, the adjacent basic coil segments which are not aligned with each other will be welded. The welding adjacent basic coil segments which are not aligned with each other may cause low welding quality and reduced productivity of the rotary electric machine stator.

An object of an aspect of the present invention is to suppress a decrease in productivity of a rotary electric machine stator.

### Solution to Problem

According to an aspect of the present invention, a rotary electric machine stator comprises: a stator core that includes a slot having an insertion end and a welded end; a basic coil segment that includes a pair of basic coil insertion end portions and a basic coil bent portion arranged between the pair of basic coil insertion end portions; and a power coil segment that includes a power coil insertion end portion, a power coil lead end portion, and a power coil connection portion arranged between the power coil insertion end portion and the power coil lead end portion, wherein the basic coil segment is arranged in the slot such that at least part of the basic coil bent portion is arranged outside the insertion end, in an axial direction parallel to a center axis of the stator core, and the pair of the basic coil insertion end portions is arranged outside the welded end, in the axial direction, the power coil segment is arranged in the slot such that the power coil lead end portion and at least part of the power coil connection portion are arranged outside the insertion end, in the axial direction, and the power coil insertion end portion is arranged outside the welded end, in the axial direction, and a height of an end surface of the basic coil segment from the insertion end is equal to a height of an end surface of the power coil segment from the insertion end.

### Advantageous Effects of Invention

According to an aspect of the present invention, it is possible to suppress a decrease in the productivity of the rotary electric machine stator.

### BRIEF DESCRIPTION OF DRAWINGS

FIG. 1 is a diagram schematically illustrating a rotary electric machine according to an embodiment.

FIG. 2 is a perspective view illustrating a rotary electric machine stator according to the embodiment.

FIG. 3 is a perspective view illustrating a rectangular wire according to the embodiment.

FIG. 4 is a perspective view illustrating a basic coil segment according to the embodiment.

FIG. 5 is a perspective view illustrating a power coil segment according to the embodiment.

FIG. 6 is a perspective view illustrating how the rotary electric machine stator according to the embodiment is manufactured.

FIG. 7 is a perspective view illustrating part of the rotary electric machine stator according to the embodiment.

FIG. 8 is a diagram schematically illustrating a process of inserting each of the basic coil segments and power coil segments according to the embodiment into slots.

FIG. 9 is a diagram schematically illustrating a bending process of bending the basic coil segment and power coil segment according to the embodiment.

FIG. 10 is a diagram schematically illustrating the bending process of bending the basic coil segment and power coil segment according to the embodiment.

FIG. 11 is a perspective view illustrating part of the basic coil segments after bending according to the embodiment.

FIG. 12 is a diagram schematically illustrating a process of welding the basic coil segments according to the embodiment.

FIG. 13 is a perspective view illustrating part of a U-phase basic coil and U-phase power coil according to the embodiment.

FIG. 14 is a perspective view illustrating the U-phase basic coil and U-phase power coil according to the embodiment.

### DESCRIPTION OF EMBODIMENTS

Embodiments according to the present invention will be described below with reference to the drawings, but the present invention is not limited thereto. Component elements of the embodiments described below may be appropriately combined with each other. Furthermore, some of the component elements may not be used.

[Rotary Electric Machine]

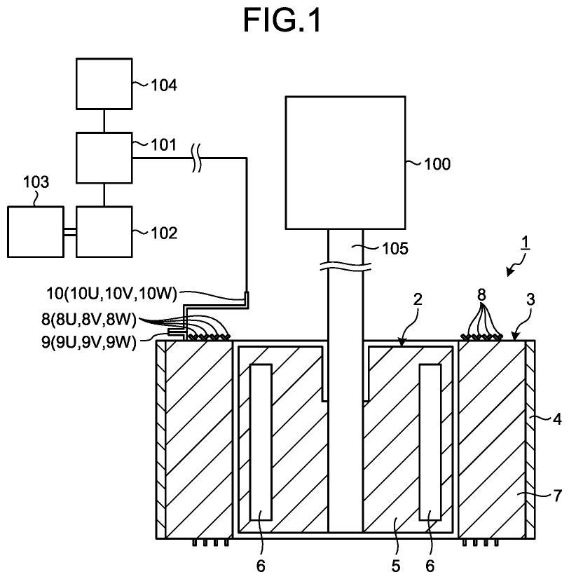

FIG. 1 is a diagram schematically illustrating a rotary electric machine 1 according to an embodiment. As illustrated in FIG. 1, the rotary electric machine 1 includes a rotary electric machine rotor 2, a rotary electric machine stator 3 that is arranged around the rotary electric machine rotor 2, and a housing 4 that is arranged around the rotary electric machine stator 3. The rotary electric machine stator 3 has a substantially cylindrical shape. An outer peripheral surface of the rotary electric machine rotor 2 and an inner peripheral surface of the rotary electric machine stator 3 face each other across a gap. A rotating shaft of the rotary electric machine rotor 2 and the center axis of the rotary electric machine stator 3 substantially coincide with each other. The rotary electric machine rotor 2 is connected to an object 100 via a shaft 105. An example of the object 100 includes an upper swing body of a hybrid excavator, which is a kind of construction machine.

The rotary electric machine rotor 2 includes a rotor core 5 and a permanent magnet 6 that is supported by the rotor core 5. The rotary electric machine stator 3 includes a stator core 7, a basic coil 8 that is wound around the stator core 7, and a power coil 9 that is connected to the basic coil 8. The power coil 9 is connected to a power line 10. Note that the rotary electric machine rotor 2 may not have the permanent magnet 6. An example of a type of motor with no permanent magnet 6 includes at least one of a switched reluctance motor and an induction motor.

The power line 10 is connected to each of a generator 102 and a power storage device 104 via an inverter 101. The generator 102 is connected to an engine 103. The generator 102 generates electric power by driving the engine 103. The power storage device 104 stores electric power. Examples of the power storage device 104 include capacitors, such as electric double-layer capacitors or lithium ion capacitors, and storage batteries, such as lead storage batteries and lithium-ion batteries.

The rotary electric machine 1 functions as an electric motor and a generator. When the rotary electric machine 1 functions as the electric motor, electric power generated by the generator 102 is supplied to the rotary electric machine stator 3 via the inverter 101 and the power line 10. In response to the supplying power to the rotary electric machine stator 3, the rotary electric machine rotor 2 rotates. The rotation of the rotary electric machine rotor 2 rotates the object 100. When the rotary electric machine 1 functions as the generator, a rotational energy of the object 100 is input to the rotary electric machine rotor 2. In response to input of the rotational energy of the object 100 to the rotary electric machine rotor 2, the rotary electric machine 1 generates electric power. The electric power generated by the rotary electric machine 1 is stored in the power storage device 104 via the power line 10 and the inverter 101.

The rotary electric machine 1 has a three-phase synchronous motor. The basic coil 8 includes a U-phase basic coil 8U, a V-phase basic coil 8V, and a W-phase basic coil 8W. The power coil 9 includes a U-phase power coil 9U, a V-phase power coil 9V, and a W-phase power coil 9W. The power line 10 includes a U-phase power line 10U, a V-phase power line 10V, and a W-phase power line 10W.

[Rotary Electric Machine Stator]

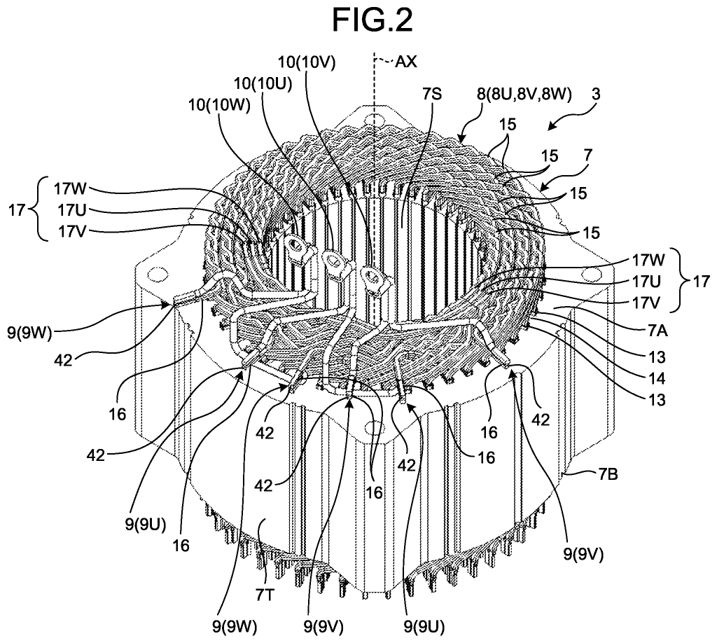

FIG. 2 is a perspective view illustrating the rotary electric machine stator 3 according to the embodiment. The rotary electric machine stator 3 has a segment conductor (SC) wound stator. The rotary electric machine stator 3 includes the stator core 7 in which a slot 13 is formed, the basic coil 8 that is wound around the stator core 7 so as to be at least partially arranged in the slot 13, and the power coil 9 that is at least partially connected to the basic coil 8. The basic coil 8 is connected to a neutral line 17. The power coil 9 is connected to a power line 10.

The stator core 7 has a substantially cylindrical shape. The stator core 7 has a center axis AX that coincides with the center axis of the rotary electric machine stator 3. In the following description, a direction parallel to the center axis AX of the stator core 7 is appropriately referred to as an axial direction, a rotation direction around the center axis AX is appropriately referred to as a circumferential direction, and a radial direction with respect to the center axis AX is appropriately referred to as a radial direction. Furthermore, a direction or position away from the center axis AX in a radial direction is appropriately referred to as radially outward or radial outside, and a direction or position approaching the center axis AX in a radial direction is appropriately referred to as radially inward or radial inside.

The stator core 7 has an inner peripheral surface 7S, an outer peripheral surface 7T, a first end surface 7A, and a second end surface 7B. The inner peripheral surface 7S faces the center axis AX. The outer peripheral surface 7T faces in the opposite direction to the inner peripheral surface 7S. The first end surface 7A connects one end portion of the inner peripheral surface 7S and one end portion of the outer peripheral surface 7T, in the axial direction. The second end surface 7B connects the other end of the inner peripheral surface 7S and the other end of the outer peripheral surface 7T in the axial direction.

A plurality of the slots 13 is provided in the inner peripheral surface 7S in the circumferential direction. Each of the slots 13 is recessed radially outward from the inner peripheral surface 7S. Between adjacent slots 13 in the circumferential direction, a tooth 14 of the stator core 7 is arranged.

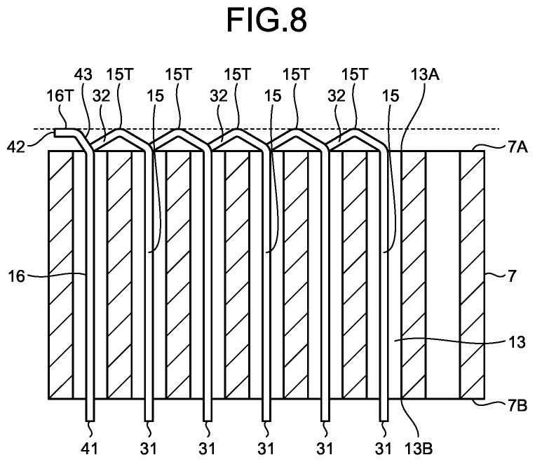

The slot 13 extends in the axial direction. The slot 13 has an insertion end 13A and a welded end 13B, as illustrated in FIG. 8 which is described later. The insertion end 13A represents one end of the slot 13 in the axial direction and is connected to the first end surface 7A. The welded end 13B represents the other end of the slot 13 in the axial direction and is connected to the second end surface 7B. The insertion end 13A includes an opening portion that is defined in the first end surface 7A. The welded end 13B includes an opening portion that is defined in the second end surface 7B.

The basic coil 8 includes a plurality of basic coil segments 15. The basic coil 8 is wound around the stator core 7 by an SC winding method. The SC winding method is a method in which the plurality of basic coil segments 15 formed by segment conductors (split conductors) is inserted into the slots 13 of the stator core 7, and then adjacent basic coil segments 15 are welded to wind the basic coil 8 around the stator core 7.

A plurality of basic coil segments 15 forms the U-phase basic coil 8U. A plurality of basic coil segments 15 forms the V-phase basic coil 8V. A plurality of basic coil segments 15 forms the W-phase basic coil 8W.

The power coil 9 includes a plurality of power coil segments 16 formed by segment conductors. A pair of power coil segments 16 forms the U-phase power coil 9U. A pair of power coil segments 16 forms the V-phase power coil 9V. A pair of power coil segments 16 forms the W-phase power coil 9W.

The power line 10 includes the U-phase power line 10U that is connected to the U-phase power coil 9U, the V-phase power line 10V that is connected to the V-phase power coil 9V, and the W-phase power line 10W that is connected to the W-phase power coil 9W.

The neutral line 17 includes a U-phase neutral line 17U that is connected to the U-phase basic coil 8U, a V-phase neutral line 17V that is connected to the V-phase basic coil 8V, and a W-phase neutral line 17W that is connected to the W-phase basic coil 8W.

[Rectangular Wire]

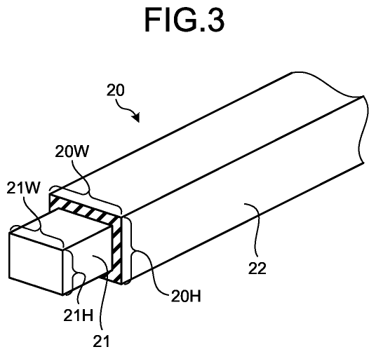

FIG. 3 is a perspective view illustrating a rectangular wire 20 according to the embodiment. As illustrated in FIG. 3, the rectangular wire 20 includes a conductor 21 and an insulating film 22 that at least partially covers the surface of the conductor 21. The conductor 21 has a rectangular cross-sectional shape having a long side 21W and a short side 21H. The rectangular wire 20 (insulating film 22) has a rectangular cross-sectional shape having a long side 20W and a short side 20H. The long side 20W of the rectangular wire 20 has a dimension of approximately 3.0 [mm], and the short side 20H of the rectangular wire 20 has a dimension of approximately 2.5 [mm], but the long side 20W and the short side 20H are not limited thereto.

The conductor 21 may have a square cross-sectional shape. Furthermore, the rectangular wire 20 (insulating film 22) may have a square cross-sectional shape.

Each of the basic coil segment 15 and the power coil segment 16 is formed from the rectangular wire 20. The basic coil segment 15 (basic coil 8) is formed from the rectangular wire 20, and thereby, the coil space factor in the rotary electric machine stator 3 is improved. The coil space factor represents a proportion of the conductor 21 in a cross-section of the rotary electric machine stator 3. The improved coil space factor makes it possible to reduce the size of the rotary electric machine 1 and increase the output therefrom.

[Basic Coil Segment]

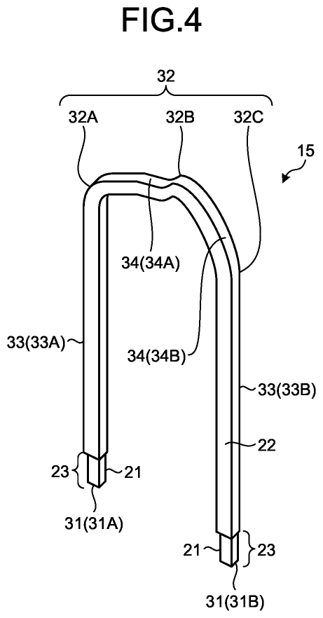

FIG. 4 is a perspective view illustrating the basic coil segment 15 according to the embodiment. The basic coil segment 15 is manufactured by molding a straight rectangular wire 20 by a die or bending.

As illustrated in FIG. 4, the basic coil segment 15 has a pair of basic coil insertion end portions 31 and a basic coil bent portion 32 arranged between the pair of basic coil insertion end portions 31.

The basic coil insertion end portions 31 include a first basic coil insertion end portion 31A and a second basic coil insertion end portion 31B. The basic coil bent portion 32 includes a first basic coil bent portion 32A, a second basic coil bent portion 32B, and a third basic coil bent portion 32C.

The basic coil segment 15 has a pair of basic coil straight portions 33 each of which includes the basic coil insertion end portion 31, and a pair of basic coil curved portions 34. The basic coil straight portions 33 include a first basic coil straight portion 33A that includes the first basic coil insertion end portion 31A and a second basic coil straight portion 33B that includes the second basic coil insertion end portion 31B. The basic coil curved portions 34 include a first basic coil curved portion 34A and a second basic coil curved portion 34B. The first basic coil straight portion 33A is connected to the first basic coil curved portion 34A via the first basic coil bent portion 32A. The first basic coil curved portion 34A is connected to the second basic coil curved portion 34B via the second basic coil bent portion 32B. The second basic coil curved portion 34B is connected to the second basic coil straight portion 33B via the third basic coil bent portion 32C.

When viewed in the axial direction, the first basic coil curved portion 34A and the second basic coil curved portion 34B are curved in the circumferential direction. The first basic coil curved portion 34A and the second basic coil curved portion 34B are connected at the second basic coil bent portion 32B. The second basic coil curved portion 34B is arranged at a position displaced from the first basic coil curved portion 34A in the radial direction. When viewed in the radial direction, the first basic coil curved portion 34A extends substantially obliquely from the first end surface 7A toward the second basic coil bent portion 32B. The second basic coil curved portion 34B extends substantially obliquely from the second basic coil bent portion 32B toward the first end surface 7A.

The first basic coil straight portion 33A and the second basic coil straight portion 33B are substantially parallel to each other. The first basic coil insertion end portion 31A and the second basic coil insertion end portion 31B face in the same direction.

The basic coil segment 15 includes the conductor 21 and the insulating film 22 that at least partially covers the surface of the conductor 21. Each of the basic coil straight portions 33 including the basic coil insertion end portion 31 has a portion formed as a conductor exposed portion 23 in which the surface of the conductor 21 is not covered with the insulating film 22.

[Power Coil Segment]

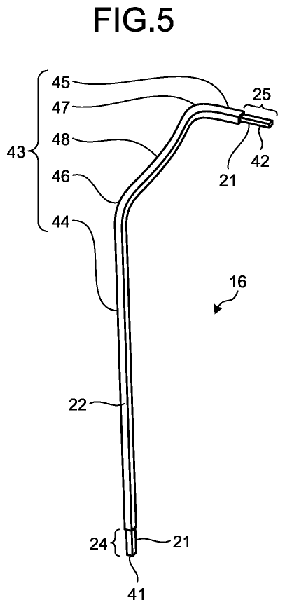

FIG. 5 is a perspective view illustrating the power coil segment 16 according to the embodiment. The power coil segment 16 is manufactured by molding the straight rectangular wire 20 by a die or bending.

As illustrated in FIG. 5, the power coil segment 16 has a power coil insertion end portion 41, a power coil lead end portion 42, and a power coil connection portion 43 that is arranged between the power coil insertion end portion 41 and the power coil lead end portion 42.

The power coil connection portion 43 includes a first power coil straight portion 44, a second power coil straight portion 45, and a power coil curved portion 48. The first power coil straight portion 44 is connected to the power coil curved portion 48 via a first power coil bent portion 46. The power coil curved portion 48 is connected to the second power coil straight portion 45 via a second power coil bent portion 47.

The power coil segment 16 includes the conductor 21 and the insulating film 22 that at least partially covers the surface of the conductor 21. The first power coil straight portion 44 including the power coil insertion end portion 41 has a portion formed as a conductor exposed portion 24 in which the surface of the conductor 21 is not covered with the insulating film 22. The second power coil straight portion 45 including the power coil lead end portion 42 has a portion formed as a conductor exposed portion 25 in which a surface of the conductor 21 is not covered with the insulating film 22.

[Relationships of Basic Coil Segment and Power Coil Segment to Stator Core]

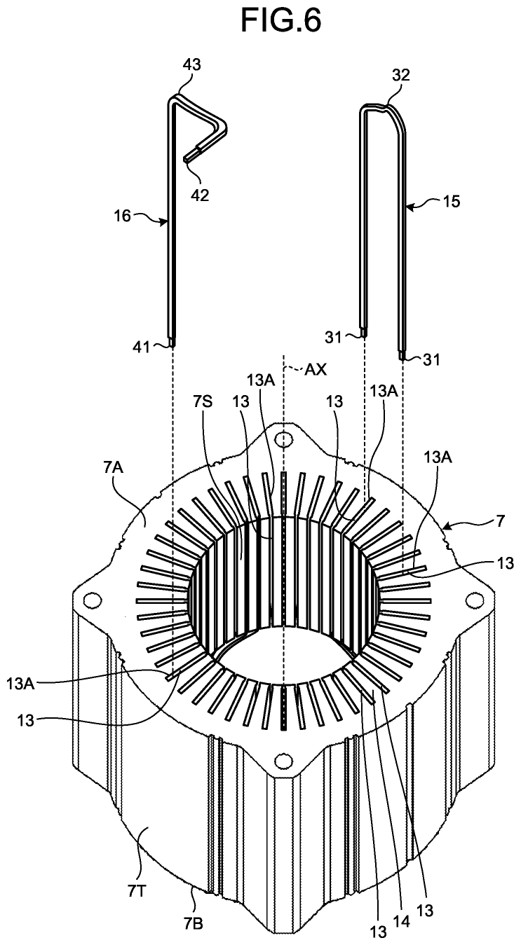

FIG. 6 is a perspective view illustrating how the rotary electric machine stator 3 according to the embodiment is manufactured. As illustrated in FIG. 6, each of the basic coil segment 15 and the power coil segment 16 is inserted into the slot 13 from the insertion end 13A of the slot 13.

In insertion of the basic coil segment 15 into the slot 13, the basic coil insertion end portion 31 of the basic coil segment 15 is inserted into the slot 13 from the insertion end 13A with the insertion end 13A of the slot 13 facing upward. The basic coil segment 15 is moved in the axial direction until the basic coil insertion end portion 31 is arranged axially outward from the welded end 13B of the slot 13. The basic coil segment 15 moves in the axial direction, and thereby the first end surface 7A and at least part of the basic coil bent portion 32 come into contact with each other. The at least partial contact between the first end surface 7A and the basic coil bent portion 32 restricts movement of the basic coil segment 15 in the axial direction. At least part of the basic coil segment 15 between the basic coil insertion end portions 31 and the basic coil bent portion 32 is arranged within the slot 13, and the basic coil bent portion 32 is arranged axially outward from the insertion end 13A of the slot 13 with the basic coil insertion end portions 31 arranged axially outward from the welded end 13B of the slot 13. In other words, the basic coil segment 15 is arranged in the slot 13 so that at least part of the basic coil bent portion 32 is arranged axially outward from the insertion end 13A and the pair of basic coil insertion end portions 31 are arranged axially outward from the welded end 13B.

In insertion of the power coil segment 16 into the slot 13, the power coil insertion end portion 41 of the power coil segment 16 is inserted into the slot 13 from the insertion end 13A with the insertion end 13A of the slot 13 facing upward. The power coil segment 16 is moved in the axial direction until the power coil insertion end portion 41 is arranged axially outward from the welded end 13B of the slot 13. The power coil segment 16 moves in the axial direction, and thereby the first end surface 7A and at least part of the power coil connection portion 43 come into contact with each other. The contact between the first end surface 7A and the at least part of the power coil connection portion 43 restricts movement of the power coil segment 16 in the axial direction. At least part of the power coil segment 16 between the power coil insertion end portion 41 and the power coil connection portion 43 is arranged within the slot 13, and the power coil connection portion 43 and the power coil lead end portion 42 are arranged outward from the insertion end 13A of the slot 13 with the power coil insertion end portion 41 arranged axially outward from the welded end 13B of the slot 13. In other words, the power coil segment 16 is arranged in the slot 13 so that the power coil lead end portion 42 and at least part of the power coil connection portion 43 are arranged axially outward from the insertion end 13A and the power coil insertion end portion 41 is arranged axially outward from the welded end 13B.

Note that FIG. 6 illustrates a state in which one basic coil segment 15 and one power coil segment 16 are inserted into the slots 13 for convenience, but as illustrated in FIG. 2, the plurality of basic coil segments 15 and the plurality of power coil segments 16 are inserted into the slots 13.

[Relationship Between Basic Coil Segment and Power Coil Segment]

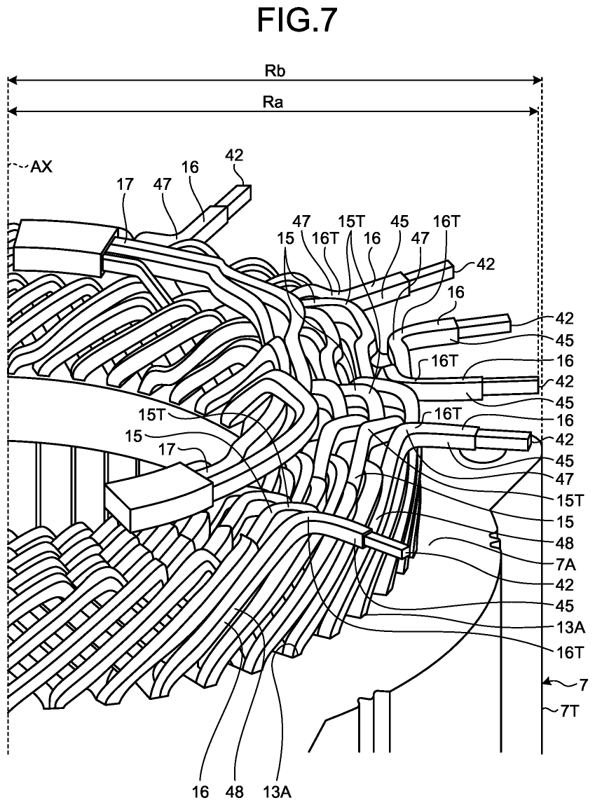

FIG. 7 is a perspective view illustrating part of the rotary electric machine stator 3 according to the embodiment. FIG. 7 illustrates a state after the plurality of basic coil segments 15 and the plurality of power coil segments 16 are inserted into the slots 13.

As described above, in a process of inserting the basic coil segment 15 into the slot 13, the basic coil segment 15 is moved in the axial direction, until the first end surface 7A and at least part of the basic coil bent portion 32 make contact with each other to restrict the movement of the basic coil segment 15 in the axial direction. Likewise, in a process of inserting the power coil segment 16 into the slot 13, the power coil segment 16 is moved in the axial direction, until the first end surface 7A and at least part of the power coil connection portion 43 make contact with each other to restrict the movement of the power coil segment 16 in the axial direction.

As illustrated in FIG. 7, the plurality of basic coil segments 15 arranged axially outward from the insertion ends 13A has end surfaces 15T of equal height. Furthermore, the height of the end surface 15T of the basic coil segment 15 from the insertion end 13A is equal to the height of an end surface 16T of the power coil segment 16 from the insertion end 13A, the basic coil segment 15 and the power coil segment 16 being arranged axially outward from the insertion ends 13A. Note that the height from the insertion end 13A means a distance in the axial direction relative to the insertion end 13A. When the rotary electric machine 1 is arranged so that the center axis AX extends in a direction of gravity (vertical axis), the direction of gravity represents a direction of the height from the insertion end 13A. When the rotary electric machine 1 is arranged so that the center axis AX is along a horizontal direction, the horizontal direction represents a direction of the height from the insertion end 13A.

The end surface 15T of the basic coil segment 15 represents a portion of the surface of the basic coil segment 15 that is farthest from the first end surface 7A of the stator core 7 in the axial direction. The end surface 16T of the power coil segment 16 represents a portion of the surface of the power coil segment 16 that is farthest from the first end surface 7A of the stator core 7 in the axial direction.

The plurality of end surfaces 15T which is equal in height also includes the plurality of end surfaces 15T that is not only completely equal in height but also substantially equal in height. The plurality of end surfaces 15T which is substantially equal in height includes the plurality of end surfaces 15T that has a displacement amount therebetween in height being half or less of a dimension of the short side 20H of the rectangular wire 20.

The fact that the end surface 15T and the end surface 16T are equal in height includes the fact that the end surface 15T and the end surface 16T are not only completely equal in height but also substantially equal in height. The fact that the end surface 15T and the end surface 16T are substantially equal in height includes a state in which the end surface 15T and the end surface 16T have a displacement amount therebetween in height being half or less of the dimension of the short side 20H of the rectangular wire 20.

Note that in a case where the rectangular wire 20 has a square cross-section, the fact that the plurality of end surfaces 15T is substantially equal in height includes a state in which the plurality of end surfaces 15T has a displacement amount therebetween in height being half or less of a dimension of one side of the cross-section of the rectangular wire 20. The fact that the end surface 15T and the end surface 16T are substantially equal in height includes a state in which the end surface 15T and the end surface 16T have a displacement amount therebetween in height being half or less of the dimension of one side of the cross-section of the rectangular wire 20.

Note that the fact that the plurality of end surfaces 15T is equal in height essentially includes a state in which the plurality of end surfaces 15T can simultaneously make contact with a support surface 51 of a support member 50, which is described later, when the plurality of basic coil segments 15 inserted in the slots 13 faces the support surface 51.

Note that the fact that the end surface 15T and the end surface 16T are equal in height essentially includes a state in which the end surface 15T and the end surface 16T can simultaneously make contact with the support surface 51 of the support member 50 described later, when the basic coil segment 15 and power coil segment 16 that are inserted into the slots 13 face the support surface 51.

[Relationship Between Power Coil Segment and Stator Core]

At least part of the first power coil straight portion 44 of the power coil segment 16 is arranged in the slot 13. As illustrated in FIG. 7, the power coil curved portion 48 extends in the circumferential direction around the center axis AX with at least part of the first power coil straight portion 44 arranged in the slot 13. Furthermore, the second power coil straight portion 45 extends radially outward with respect to the center axis AX with at least part of the first power coil straight portion 44 arranged in the slot 13.

Furthermore, when at least part of the first power coil straight portion 44 is arranged in the slot 13, the height of the second power coil bent portion 47 from the insertion end 13A is equal to the height of the power coil lead end portion 42 from the insertion end 13A. In other words, the second power coil straight portion 45 extends radially outward so as to be orthogonal to the center axis AX.

Furthermore, the power coil lead end portion 42 is arranged outside the basic coil segment 15 in the radial direction with respect to the center axis AX.

Furthermore, in the radial direction with respect to the center axis AX, a distance Ra from the center axis AX to the power coil lead end portion 42 is smaller than the maximum value of a distance Rb from the center axis AX to the outer peripheral surface 7T of the stator core 7. In other words, the power coil segment 16 is arranged so that the power coil lead end portion 42 does not protrude radially outward from the outer peripheral surface 7T of the stator core 7.

The plurality of (six) power coil segments 16 is spaced from each other in the circumferential direction around the center axis AX. In the radial direction with respect to the center axis AX, the distance Ra from the center axis AX to the power coil lead end portion 42 of a first power coil segment 16 is equal to the distance Ra from the center axis AX to the power coil lead end portion 42 of a second power coil segment 16 adjacent to the first power coil segment 16. In other words, each of the distance Ra from the center axis AX to each of the power coil lead end portions 42 of the plurality of the power coil segments 16 is equal.

[Production Method]

FIG. 8 is a diagram schematically illustrating a process of inserting each of the basic coil segments 15 and power coil segments 16 according to the embodiment into the slots 13. As illustrated in FIG. 8, each of the basic coil segments 15 and the power coil segment 16 is inserted into the slot 13 from the insertion end 13A with the insertion end 13A of the slot 13 facing upward and the welded end 13B of the slot 13 facing downward.

The basic coil segment 15 is inserted into the slot 13 from the basic coil insertion end portion 31. After the basic coil insertion end portion 31 is inserted into the insertion end 13A, the basic coil segment 15 moves in the axial direction, and thereby the first end surface 7A makes contact with at least part of the basic coil bent portion 32. The movement of the basic coil segment 15 in the axial movement is restricted by the contact between the first end surface 7A and the at least part of the basic coil bent portion 32. When the first end surface 7A is in contact with the at least part of the basic coil bent portion 32, the basic coil insertion end portion 31 is arranged outside the welded end 13B of the slot 13.

The power coil segment 16 is inserted into the slot 13 from the power coil insertion end portion 41 thereof. After the power coil insertion end portion 41 is inserted into the insertion end 13A, the power coil segment 16 moves in the axial direction, and thereby the first end surface 7A makes contact with at least part of the power coil connection portion 43. The contact between the first end surface 7A and the at least part of the power coil connection portion 43 restricts movement of the power coil segment 16 in the axial direction. When the first end surface 7A is in contact with the at least part of the power coil connection portion 43, the power coil insertion end portion 41 is arranged axially outward from the welded end 13B of the slot 13.

Each of the basic coil segment 15 and power coil segment 16 is manufactured so that the height of the end surface 15T from the insertion end 13A is equal to the height of the end surface 16T from the insertion end 13A with the axial movement of each of the basic coil segment 15 and power coil segment 16 restricted in the slot 13.

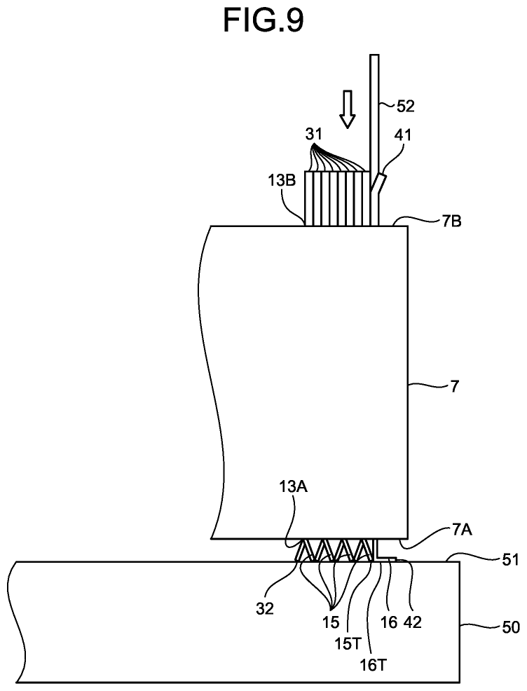

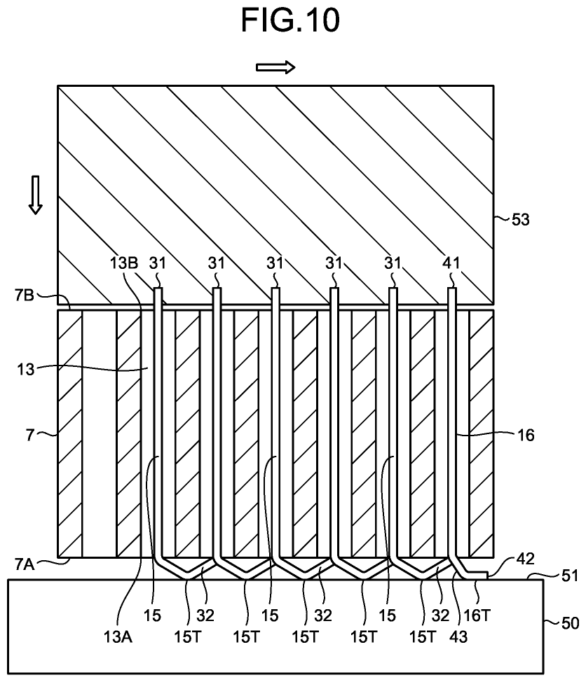

Each of FIGS. 9 and 10 is a diagram schematically illustrating a bending process of bending the basic coil segment 15 and power coil segment 16 according to the embodiment. The bending process includes an expansion process and a twisting process, and in the expansion process, the plurality of basic coil segments 15 and the power coil segment 16 that are arranged axially outward from the welded ends 13B of the slots 13 are bent so as to be radially separated from each other, and in the twisting process, after the expansion process, the plurality of basic coil segments 15 and the power coil segment 16 that are arranged axially outward from the welded ends 13B are bent so as to be twisted circumferentially. FIG. 9 illustrates the expansion process, and FIG. 10 includes the twisting process. The expansion process is performed to suppress a decrease in welding workability, which will be described later.

As illustrated in FIG. 9, after the basic coil segments 15 and the power coil segment 16 are arranged in the slots 13, the stator core 7 is vertically inverted so that the welded ends 13B of the slots 13 face upward and the insertion ends 13A of the slots 13 face downward. When the welded ends 13B of the slots 13 face upward, the basic coil insertion end portions 31 and the power coil insertion end portion 41 also face upward. The vertically inverted stator core 7 is supported by the support surface 51 (upper surface) of the support member 50. The support surface 51 is a flat surface facing upward. The support member 50 is installed so that the support surface 51 is parallel to a horizontal plane.

At least part of the basic coil segments 15 and at least part of the power coil segment 16 are arranged below the insertion ends 13A. Supporting the stator core 7 by the support surface 51 includes bringing the basic coil segments 15 and the power coil segment 16 arranged below the insertion ends 13A into contact with the support surface 51.

The height of the end surface 15T of each of the basic coil segments 15 from the insertion end 13A is equal to the height of the end surface 16T of the power coil segment 16 from the insertion end 13A, the basic coil segment 15 and the power coil segment 16 being arranged below the insertion ends 13A. Furthermore, the support surface 51 is a flat surface. Therefore, it is possible for both of the end surface 15T of the basic coil segment 15 and the end surface 16T of the power coil segment 16 to make contact with the support surface 51 simultaneously.

The expansion process is performed while the basic coil segment 15 and the power coil segment 16 that protrude downward from the insertion ends 13A of the slots 13 are supported by the support surface 51 of the support member 50.

As illustrated in FIG. 9, the basic coil segment 15 and the power coil segment 16 arranged above the welded ends 13B are bent so as to be radially separated from each other by a tool 52 used for the expansion process with both the end surface 15T and the end surface 16T supported by the support surface 51. The tool 52 applies a force downward from above, to the basic coil segment 15 and the power coil segment 16 that are arranged above the welded ends 13B. The tool 52 being arranged between the basic coil segment 15 and the power coil segment 16 radially adjacent to each other moves downward, and thereby the adjacent basic coil segment 15 and the power coil segment 16 are bent so as to be radially separated. Furthermore, the tool 52 being arranged between the basic coil segments 15 radially adjacent to each other moves downward, and thereby the adjacent basic coil segments 15 are bent so as to be radially separated.

The expansion process is performed with both the end surface 15T and the end surface 16T making contact with the support surface 51. In other words, the tool 52 used for the expansion process applies a force downward from above, to the basic coil segment 15 and the power coil segment 16, with the basic coil segment 15 and the power coil segment 16 evenly supported by the support member 50. When the tool 52 applies an axial force to the basic coil segment 15 and the power coil segment 16, both the end surface 15T and the end surface 16T are in contact with the support surface 51, thereby suppressing axial displacement of at least one of the basic coil segment 15 and the power coil segment 16 relative to the slot 13, in the expansion process.

After the diameter expansion process is finished, the twisting process is performed. As in the expansion process, the twisting process is performed while the welded ends 13B of the slots 13 face upward and the insertion ends 13A of the slots 13 face downward. Furthermore, as in the expansion process, the twisting process is performed while the basic coil segment 15 and the power coil segment 16 that protrude downward from the insertion ends 13A of the slots 13 are supported by the support surface 51 of the support member 50. Note that the support member 50 used in the expansion process and the support member 50 used in the twisting process may be the same support member or different support members.

As illustrated in FIG. 10, the basic coil segment 15 and the power coil segment 16 arranged above the welded ends 13B are bent so as to be circumferentially twisted by a tool 53 used for the twisting process with both the end surface 15T and the end surface 16T supported by the support surface 51. The tool 53 applies a force downward from above, to the basic coil segment 15 and the power coil segment 16 that are arranged above the welded ends 13B. The basic coil segment 15 and the power coil segment 16 are inserted into recesses of the tool 53 with the end surface 15T and the end surface 16T supported by the support surface 51. The tool 53 circumferentially rotates while moving downward with the basic coil segment 15 and the power coil segment 16 inserted into the recesses of the tool 53. The circumferential rotation of the tool 53 while moving downward makes it possible to bend the basic coil segment 15 and the power coil segment 16 so as to twist circumferentially.

As in the expansion process, the twisting process is performed with both the end surface 15T and the end surface 16T making contact with the support surface 51. In other words, the tool 53 used for the twisting process applies a force downward from above, to the basic coil segment 15 and the power coil segment 16, with the basic coil segment 15 and the power coil segment 16 evenly supported by the support member 50. When the tool 53 applies an axial force to the basic coil segment 15 and the power coil segment 16, both the end surface 15T and the end surface 16T are in contact with the support surface 51, thereby suppressing axial displacement of at least one of the basic coil segment 15 and the power coil segment 16 relative to the slot 13, also in the twisting process.

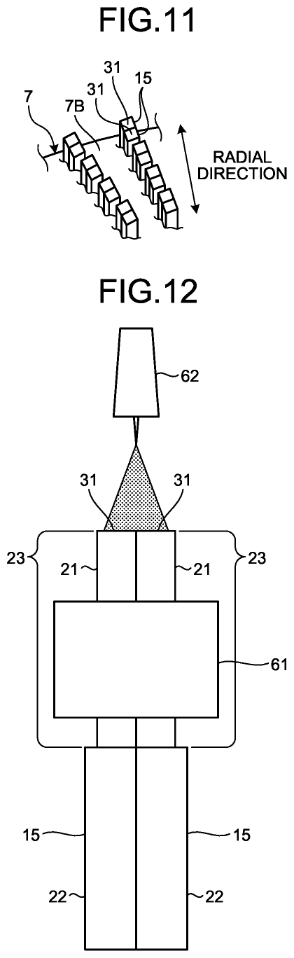

FIG. 11 is a perspective view illustrating part of the basic coil segments 15 after bending according to the embodiment. As described with reference to FIGS. 9 and 10, the basic coil segments 15 are bent by the tools 52 and 53 with the end surfaces 15T and the end surface 16T supported by the support surface 51, thereby preventing adjacent basic coil segments 15 having uneven height in the axial direction. Even after the bending, the height of the basic coil insertion end portion 31 of one of the adjacent basic coil segments 15 from the insertion end 13A is the same as the height of the basic coil insertion end portion 31 of the other from the insertion end 13A.

FIG. 12 is a diagram schematically illustrating a process of welding the basic coil segments 15 according to the embodiment. After the basic coil segments 15 and the power coil segment 16 are bent, the adjacent basic coil insertion end portions 31 are joined by arc welding. In the welding, the adjacent basic coil segments 15 are held by a clamp electrode 61. A welding torch 62 is arranged so as to face the adjacent basic coil insertion end portions 31. The height of the basic coil insertion end portion 31 of one of the adjacent basic coil segments 15 from the insertion end 13A is the same as the height of the basic coil insertion end portion 31 of the other from the insertion end 13A. Therefore, the adjacent basic coil insertion end portions 31 are satisfactorily joined by arc welding. Welding the adjacent basic coil insertion end portions 31 connects the plurality of basic coil segments 15, and thereby the basic coil 8 is wound around the stator core 7.

As illustrated in FIG. 12, in the plurality of basic coil segments 15, the conductor exposed portions 23 have equal dimensions. Therefore, the clamp electrode 61 is allowed to satisfactorily hold the plurality of basic coil segments 15.

[Basic Coil and Power Coil]

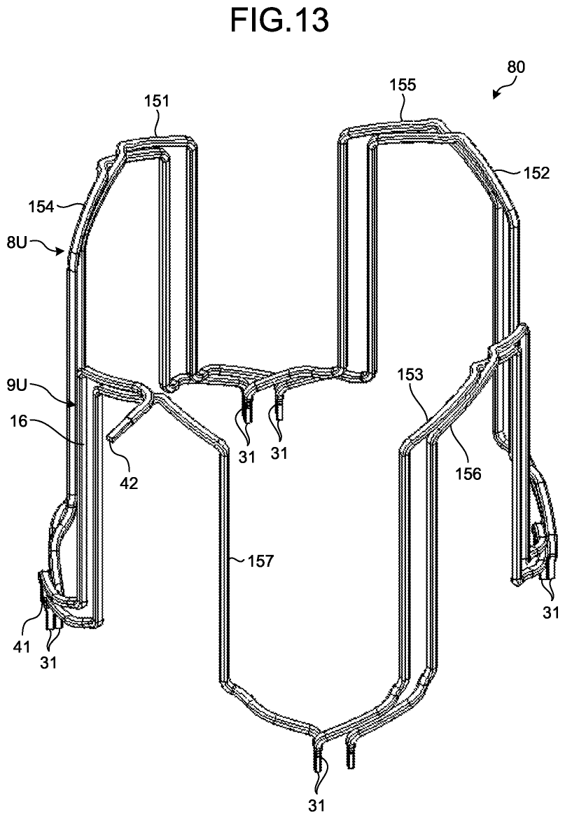

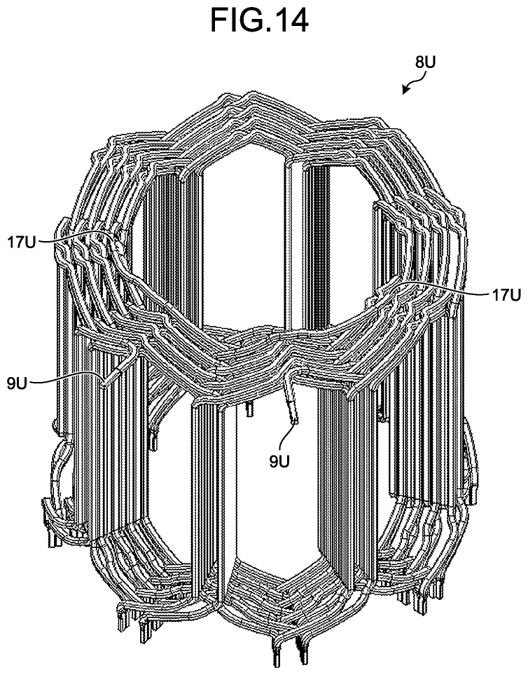

FIG. 13 is a perspective view illustrating part of the U-phase basic coil 8U and U-phase power coil 9U according to the embodiment. Note that in FIG. 13, the stator core 7 is not illustrated. The U-phase basic coil 8U includes four basic coil units 80 arranged in the radial direction. FIG. 13 illustrates the basic coil unit 80 that is radially arranged on the outermost side from among the radially arranged four basic coil units 80.

As illustrated in FIG. 13, the basic coil unit 80 includes seven basic coil segments 15 (151, 152, 153, 154, 155, 156, and 157). The seven basic coil segments 15 are connected so as to be wound around the center axis AX twice. The basic coil segments 151, 152, and 153 form the first continuous coil unit, and the basic coil segments 154, 155, and 156 form the second continuous coil unit. The basic coil segment 151 and the basic coil segment 154 at least partially overlap each other in the circumferential direction. The basic coil segment 152 and the basic coil segment 155 at least partially overlap each other in the circumferential direction. The basic coil segment 153 and the basic coil segment 156 at least partially overlap each other in the circumferential direction.

One basic coil insertion end portion 31 of the basic coil segment 151 and the other basic coil insertion end portion 31 of the basic coil segment 152 are welded together. One basic coil insertion end portion 31 of the basic coil segment 152 and the other basic coil insertion end portion 31 of the basic coil segment 153 are welded together.

One basic coil insertion end portion 31 of the basic coil segment 154 and the other basic coil insertion end portion 31 of the basic coil segment 155 are welded together. One basic coil insertion end portion 31 of the basic coil segment 155 and the other basic coil insertion end portion 31 of the basic coil segment 156 are welded together.

The other basic coil insertion end portion 31 of the basic coil segment 151 and one basic coil insertion end portion 31 of the basic coil segment 157 are welded together. One basic coil insertion end portion 31 of the basic coil segment 156 and the other basic coil insertion end portion 31 of the basic coil segment 157 are welded together. The first continuous coil unit and the second continuous coil unit are connected via the basic coil segment 157.

The power coil insertion end portion 41 of the power coil segment 16 is welded to the basic coil insertion end portion 31 of the basic coil segment 151.

The current supplied to the power coil lead end portion 42 of the power coil segment 16 passes through the power coil segment 16 and then sequentially passes through the basic coil segment 151, the basic coil segment 152, and the basic coil segment 151. The current flowing through the basic coil segment 151 is supplied to the basic coil segment 157. The current flowing through the basic coil segment 157 sequentially flows through the basic coil segment 154, the basic coil segment 155, and the basic coil segment 156.

FIG. 14 is a perspective view illustrating the U-phase basic coil 8U and U-phase power coil 9U according to the embodiment. The four basic coil units 80 are radially arranged, and thereby the U-phase basic coil 8U is manufactured. In the embodiment, two U-phase basic coils 8U are provided. In other words, the rotary electric machine 1 is a three-phase two-pole synchronous motor. The U-phase basic coil 8U is provided with the two U-phase power coils 9U and the two U-phase neutral lines 17U.

As in the U-phase basic coil 8U illustrated in FIG. 14, the V-phase basic coil 8V and the W-phase basic coil 8W are manufactured. The U-phase basic coil 8U, the V-phase basic coil 8V, the W-phase basic coil 8W, the U-phase power coil 9U, the V-phase power coil 9V, and the W-phase power coil 9W are combined to manufacture the rotary electric machine stator 3 as illustrated in FIG. 2.

[Connection Structure Between Power Coil Segment and Power Line]

As illustrated in FIG. 2, the conductor exposed portion 25 of the power coil segment 16 including the power coil lead end portion 42 is connected to the power line 10.

### Effects

As described above, when each of the basic coil segment 15 and power coil segment 16 is being inserted into the slot 13, the end surface 15T of the basic coil segment 15 and the end surface 16T of the power coil segment 16 are arranged outside the insertion ends 13A, and the height of the end surface 15T from the insertion end 13A is equal to the height of the end surface 16T from the insertion end 13A. Therefore, as described with reference to FIGS. 9 and 10, in the bending process of the basic coil segment 15 and the power coil segment 16, it is possible for the tools 52 and 53 used for the bending process to apply a force to the basic coil segment 15 and the power coil segment 16 downward from above with the basic coil segment 15 and the power coil segment 16 evenly supported by the support member 50. When the force is applied to the basic coil segment 15 and the power coil segment 16 downward from above by the tools 52 and 53, the end surface 15T of the basic coil segment 15 and the end surface 16T of the power coil segment 16 simultaneously make contact with the support surface 51 of the support member 50, and thereby displacement of the axial position of the basic coil segment 15 relative to the slot 13 or displacement of the axial position of the power coil segment 16 relative to the slot 13 is suppressed. Suppression in displacement of the axial positions of the basic coil segment 15 and the power coil segment 16 relative to the slots 13 makes it possible to weld the adjacent basic coil segments 15 in a state where the adjacent basic coil insertion end portions 31 are equal in height from each insertion end 13A, as described with reference to FIG. 12. Therefore, a decrease in welding quality is suppressed, and a decrease in productivity of the rotary electric machine stator 3 is suppressed.

As described with reference to FIG. 7, the power coil lead end portion 42 is arranged outside the basic coil segment 15 in the radial direction with respect to the center axis AX. In other words, the power coil segment 16 is inserted into the slot 13 so as not to be close to the basic coil segment 15 in a plane orthogonal to the center axis AX. This configuration suppresses generation of electrical noise, even if a voltage is applied between the power line 10 and the neutral line 17.

Furthermore, as described with reference to FIG. 7, in the radial direction with respect to the center axis AX, the distance Ra from the center axis AX to the power coil lead end portion 42 is smaller than the maximum value of the distance Rb from the center axis AX to the outer peripheral surface 7T of the stator core 7. This configuration suppresses contact between the power coil segment 16 and the housing 4 arranged around the rotary electric machine stator 3. Furthermore, the distance Ra from the center axis AX to the power coil lead end portion 42 is smaller than the maximum value of the distance Rb from the center axis AX to the outer peripheral surface 7T of the stator core 7, and thereby an increase in size of the rotary electric machine stator 3 can be suppressed.

When the plurality of power coil segments 16 is arranged at intervals in the circumferential direction, the distances Ra from the center axis AX to the power coil lead end portions 42 of the plurality of power coil segments 16 are equal to each other. This configuration makes the electrical characteristics of the plurality of power coils 9, such as electric resistance, uniform, and thus, a reduction in performance of the rotary electric machine 1 is suppressed.

As described with reference to FIG. 7, the power coil curved portion 48 extends in the circumferential direction around the center axis AX and the second power coil straight portion 45 extends radially outward with respect to the center axis AX, in a state where at least part of the first power coil straight portion 44 arranged in the slot 13. This configuration makes it possible to increase the contact area between the power coil segment 16 and the support surface 51 of the support member 50, in the bending process, and the rotary electric machine stator 3 is stably supported by the support surface 51.

Furthermore, the power coil curved portion 48 extends in the circumferential direction around the center axis AX and the second power coil straight portion 45 extends radially outward with respect to the center axis AX, thereby suppressing an increase in size of the rotary electric machine stator 3 in the axial direction.

The height of the second power coil bent portion 47 from the insertion end 13A is equal to the height of the power coil lead end portion 42 from the insertion end 13A. This configuration makes it possible to bring the entire second power coil straight portion 45 into contact with the support surface 51, in bending, and thus, the contact area between the power coil segment 16 and the support surface 51 of the support member 50 can be increased and the rotary electric machine stator 3 is stably supported by the support surface 51. Furthermore, the second power coil straight portion 45 is arranged so as to extend in the radial direction with respect to the center axis AX, thus suppressing a reduction in workability of welding the power coil lead end portion 42 and the power line 10. For example, when the power coil lead end portion 42 and the power line 10 are welded while rotating the stator core 7 around the center axis AX, the power coil lead end portion 42 and the power line 10 are smoothly welded.

As described with reference to FIG. 12, in the plurality of basic coil segments 15, the conductor exposed portions 23 have equal dimensions. Therefore, the clamp electrode 61 is allowed to satisfactorily hold the plurality of basic coil segments 15.

Note that in the above-described embodiment, the respective neutral lines 17 project axially from the end surfaces 15T and the end surfaces 16T. In this case, the support surface 51 of the support member 50 is provided with recessed portions for arrangement of the neutral lines 17, and thereby the end surfaces 15T and the end surfaces 16T are brought into contact with the support surface 51 simultaneously. The axial position of each end surface 15T is equal to the axial position of each end surface 16T, and thus, only a recessed portion for arrangement of each neutral line 17 is preferably provided in the support surface 51 of the support member 50. Therefore, the size of each recessed portion and the number of the recessed portions, provided in the support surface 51 are sufficiently suppressed, and the rotary electric machine stator 3 is stably supported by the support member 50 in the bending process. Furthermore, the size of each recessed portion and the number of the recessed portions, provided in the support surface 51 are sufficiently suppressed, thus, suppressing complication of positioning work when the rotary electric machine stator 3 is supported by the support member 50.

### REFERENCE SIGNS LIST

1 ROTARY ELECTRIC MACHINE
2 ROTARY ELECTRIC MACHINE ROTOR
3 ROTARY ELECTRIC MACHINE STATOR
4 HOUSING
5 ROTOR CORE
6 PERMANENT MAGNET
7 STATOR CORE
7A FIRST END SURFACE
7B SECOND END SURFACE
7S INNER PERIPHERAL SURFACE
7T OUTER PERIPHERAL SURFACE
8 BASIC COIL
8U U-PHASE BASIC COIL
8V V-PHASE BASIC COIL
8W W-PHASE BASIC COIL
9 POWER COIL
9U U-PHASE POWER COIL
9V V-PHASE POWER COIL
9W W-PHASE POWER COIL
10 POWER LINE
10U U-PHASE POWER LINE
10V V-PHASE POWER LINE
10W W-PHASE POWER LINE
13 SLOT
13A INSERTION END
13B WELDED END
14 TOOTH
15 BASIC COIL SEGMENT
15T END SURFACE
16 POWER COIL SEGMENT
16T END SURFACE
17 NEUTRAL LINE
17U U-PHASE NEUTRAL LINE
17V V-PHASE NEUTRAL LINE
17W W-PHASE NEUTRAL LINE
20 RECTANGULAR WIRE
20H SHORT SIDE
20W LONG SIDE
21 CONDUCTOR
21H SHORT SIDE
21W LONG SIDE
22 INSULATING FILM
23 CONDUCTOR EXPOSED PORTION
24 CONDUCTOR EXPOSED PORTION
25 CONDUCTOR EXPOSED PORTION
31 BASIC COIL INSERTION END PORTION
31A FIRST BASIC COIL INSERTION END PORTION
31B SECOND BASIC COIL INSERTION END PORTION
32 BASIC COIL BENT PORTION
32A FIRST BASIC COIL BENT PORTION
32B SECOND BASIC COIL BENT PORTION
32C THIRD BASIC COIL BENT PORTION
33 BASIC COIL STRAIGHT PORTION
33A FIRST BASIC COIL STRAIGHT PORTION
33B SECOND BASIC COIL STRAIGHT PORTION
34 BASIC COIL CURVED PORTION
34A FIRST BASIC COIL CURVED PORTION
34B SECOND BASIC COIL CURVED PORTION
41 POWER COIL INSERTION END PORTION
42 POWER COIL LEAD END PORTION
43 POWER COIL CONNECTION PORTION
44 FIRST POWER COIL STRAIGHT PORTION
45 SECOND POWER COIL STRAIGHT PORTION
46 FIRST POWER COIL BENT PORTION
47 SECOND POWER COIL BENT PORTION
48 POWER COIL CURVED PORTION
50 SUPPORT MEMBER
51 SUPPORT SURFACE (UPPER SURFACE)
52 TOOL
53 TOOL
61 CLAMP ELECTRODE
62 WELDING TORCH
80 BASIC COIL UNIT
100 OBJECT
101 INVERTER
102 GENERATOR
103 ENGINE
104 POWER STORAGE DEVICE
151 BASIC COIL SEGMENT
152 BASIC COIL SEGMENT
153 BASIC COIL SEGMENT
154 BASIC COIL SEGMENT
155 BASIC COIL SEGMENT
156 BASIC COIL SEGMENT
157 BASIC COIL SEGMENT
AX CENTER AXIS

1. A rotary electric machine stator comprising:
a stator core that includes a slot having an insertion end and a welded end;
a basic coil segment that includes a pair of basic coil insertion end portions and a basic coil bent portion arranged between the pair of basic coil insertion end portions; and
a power coil segment that includes a power coil insertion end portion, a power coil lead end portion, and a power coil connection portion arranged between the power coil insertion end portion and the power coil lead end portion, wherein
the basic coil segment is arranged in the slot such that at least part of the basic coil bent portion is arranged outside the insertion end, in an axial direction parallel to a center axis of the stator core, and the pair of the basic coil insertion end portions is arranged outside the welded end, in the axial direction,
the power coil segment is arranged in the slot such that the power coil lead end portion and at least part of the power coil connection portion are arranged outside the insertion end, in the axial direction, and the power coil insertion end portion is arranged outside the welded end, in the axial direction, and
a height of an end surface of the basic coil segment from the insertion end is equal to a height of an end surface of the power coil segment from the insertion end.

2. The rotary electric machine stator according to claim 1, wherein
the power coil lead end portion is arranged outside the basic coil segment in a radial direction with respect to the center axis.

3. The rotary electric machine stator according to claim 2, wherein
a distance from the center axis to the power coil lead end portion is smaller than a maximum value of a distance from the center axis to an outer peripheral surface of the stator core, in the radial direction with respect to the center axis.

4. The rotary electric machine stator according to claim 1, wherein
the power coil segment includes a first power coil segment and a second power coil segment that are spaced apart in a circumferential direction around the center axis, and
the distance from the center axis to the power coil lead end portion of the first power coil segment is equal to the distance from the center axis to the power coil lead end portion of the second power coil segment, in the radial direction with respect to the center axis.

5. The rotary electric machine stator according to claim 1, wherein
the power coil connection portion includes a first power coil straight portion, a second power coil straight portion, and a power coil curved portion,
the first power coil straight portion is connected to the power coil curved portion via a first power coil bent portion,
the power coil curved portion is connected to the second power coil straight portion via a second power coil bent portion, and
the power coil curved portion extends in the circumferential direction around the center axis and the second power coil straight portion extends radially outward with respect to the center axis, in a state where at least part of the first power coil straight portion is arranged in the slot.

6. The rotary electric machine stator according to claim 5, wherein
a height of the second power coil bent portion from the insertion end is equal to a height of the power coil lead end portion from the insertion end.

7. The rotary electric machine stator according to claim 1, wherein
the basic coil segment includes a conductor and an insulating film that at least partially covers a surface of the conductor,
part of the basic coil segment including the basic coil insertion end portion forms a conductor exposed portion in which the surface of the conductor is not covered with the insulating film, and
in a plurality of the basic coil segments, the conductor exposed portions have equal dimensions.
